(19) United States
(12) Patent Application Publication
(10) Pub. No.: US 2017/0274367 A1
(43) Pub. Date: Sep. 28, 2017

(54) PRIMER WASHCOATS FOR METAL SUBSTRATES

(71) Applicant: SDCmaterials, Inc., Tempe, AZ (US)

(72) Inventors: David BURROUGHS, Phoenix, AZ (US); Qinghua YIN, Tempe, AZ (US); Xiwang QI, Scottsdale, AZ (US); Maximilian A. BIBERGER, Scottsdale, AZ (US)

(21) Appl. No.: 15/506,167

(22) PCT Filed: Aug. 28, 2015
(86) PCT No.: PCT/US15/47525

§ 371 Date: Feb. 23, 2017

Related U.S. Application Data
(60) Provisional application No. 62/044,086, filed on Aug. 29, 2014.

(51) Int. Cl. B01J 35/04; B01J 37/08; B01J 21/02; B01J 37/02; C01F 7/02

(52) U.S. Cl. CPC B01J 35/04; B01J 37/02; C01F 7/02; B01J 21/02; B01J 37/082; B01D 53/94

(57) ABSTRACT

Metal substrates suitable for use as catalyst supports for catalytic converters are disclosed, as well as methods of making such substrates. A coating of boehmite particles in aqueous suspension is applied to the metal substrate and calcined. Any further desired washcoats can then be applied to the resulting calcined boehmite-coated metal substrate. One exemplary metal for use as a substrate is stainless steel.

### CROSS-REFERENCE TO RELATED APPLICATIONS

This application claims priority benefit of U.S. States Provisional Patent Application No. 62/044,086, filed Aug. 29, 2014. The entire contents of that application are hereby incorporated by reference herein.

### FIELD OF THE INVENTION

The invention pertains to metal substrates used as catalyst supports, such as for catalytic converters, and primer washcoats which ensure good adherence of subsequent washcoats applied to the substrate.

### BACKGROUND OF THE INVENTION

Catalytic converters are widely used to treat exhaust gases from internal combustion engines. Pollutants such as unburned hydrocarbons (HC) and carbon monoxide (CO) are oxidized to less harmful carbon dioxide (CO₂) in the two-way catalytic converters used in diesel engines, while nitrogen oxides (NOₓ) that form during combustion can be reduced to nitrogen when three-way catalytic converters, such as those used in gasoline engines, is employed.

The substrates used as the catalyst support in catalytic converters are commonly made out of ceramic materials. Cordierite, a silicate material also containing iron, magnesium, and aluminum, is a widely used material. Cordierite is a refractory material with a very low coefficient of thermal expansion. The substrates are designed to have a honeycomb internal structure. The honeycomb structure provides a large surface area on which the catalyst is deposited, in order to promote contact of the gaseous exhaust with as much catalytic material as possible.

Metal substrates have also been proposed for use as substrates, typically formed into metal foils of high surface area. Unfortunately, however, many standard washcoats used to coat substrates with catalyst do not adhere well to metallic substrates. Such washcoats will flake off of the metallic substrate, which is degrades the catalytic converter performance and is thus unacceptable.

There is thus a need for compositions and methods which promote washcoat adherence to metal substrates used as catalytic converter substrates.

### BRIEF SUMMARY OF THE INVENTION

Described herein are metal substrates having a primer layer. The substrates are suitable for use in catalytic converters.

In one embodiment, the invention embraces a coated metal substrate comprising a metal substrate and a primer layer comprising boehmite disposed directly on the metal substrate, wherein the primer layer comprises at least 80% boehmite. The metal substrate can comprise a honeycomb structure or corrugated metal foil structure. The primer layer on the metal substrate can be calcined. After calcining, the primer layer can be present in, or have a thickness of, about 0.5 g/L to about 4 g/L, such as about 1 g/L to about 4 g/L, such as about 1.5 g/L to about 4 g/L, such as about 1 g/L to about 3.5 g/L, such as about 1 g/L to about 3 g/L, such as about 1 g/L to about 2.5 g/L, such as about 1 g/L to about 2 g/L, about 1.5 g/L to about 2.5 g/L, about 1.75 g/L to about 2.25 g/L, about 2 g/L, about 1 g/L to about 3.5 g/L, about 1.5 g/L to about 3.5 g/L, such as about 2 g/L to about 4 g/L, such as about 2 g/L to about 3 g/L, about 2 g/L to about 3.5 g/L, about 2.5 g/L to about 3.5 g/L, about 2.75 g/L to about 3.25 g/L, or about 3 g/L.

The metal substrate of any of the embodiments disclosed herein can comprise stainless steel. The stainless steel can comprise at least 16% chromium. The stainless steel can comprise at least 3% aluminum. The stainless steel can comprise at least 16% chromium and at least 3% aluminum.

The coated metal substrate of any of the embodiments disclosed herein can further comprise an additional washcoat layer disposed directly on top of the primer layer.

In additional embodiments, the invention embraces a method of making a coated metal substrate comprising a) providing a metal substrate; b) forming an aqueous suspension of boehmite particles; c) applying the boehmite particle suspension to the metal substrate; and d) drying and calcining the metal substrate having the applied boehmite. In one embodiment, the metal substrate can comprise stainless steel. The stainless steel can comprise at least 16% chromium. The stainless steel can comprise at least 3% aluminum. The stainless steel can comprise at least 16% chromium and at least 3% aluminum. The water used for suspending the boehmite particles can comprise deionized water. The boehmite particle suspension can be sonicated before applying to the metal substrate. In a further embodiment, the boehmite particle suspension can be sonicated, then centrifuged after sonication, and the supernatant of the centrifuged suspension can be applied to the metal substrate. The calcining can be performed for at least about two hours at a temperature between 500° C. and 600° C. After calcining, the primer layer can be present in, or have a thickness of, about 0.5 g/L to about 4 g/L, such as about 1 g/L to about 4 g/L, such as about 1.5 g/L to about 4 g/L, such as about 1 g/L to about 3.5 g/L, such as about 1 g/L to about 3 g/L, such as about 1 g/L to about 2.5 g/L, such as about 1 g/L to about 2 g/L, about 1.5 g/L to about 2.5 g/L, about 1.75 g/L to about 2.25 g/L, about 2 g/L, about 1 g/L to about 3.5 g/L, about 1.5 g/L to about 3.5 g/L, such as about 2 g/L to about 4 g/L, such as about 2 g/L to about 3 g/L, about 2 g/L to about 3.5 g/L, about 2.5 g/L to about 3.5 g/L, about 2.75 g/L to about 3.25 g/L, or about 3 g/L.

In a further embodiment of the method, an additional washcoat layer can be deposited directly on top of the primer layer.

### DETAILED DESCRIPTION OF THE INVENTION

The current invention provides compositions and methods for obtaining good adherence of washcoats to metal substrates by use of a boehmite-comprising primer washcoat layer which is deposited on the metal substrate prior to deposition of further washcoat layers. The primer layer comprising boehmite enables use of metal substrates as catalyst supports in catalytic converters.

### Definitions

This disclosure provides several embodiments. It is contemplated that any features from any embodiment can be combined with any features from any other embodiment. In this fashion, hybrid configurations of the disclosed features are within the scope of the present invention.

When numerical values are expressed herein using the term “about” or the term “approximately,” it is understood that both the value specified, as well as values reasonably close to the value specified, are included. For example, the description “about 50° C.” or “approximately 50° C.” includes both the disclosure of 50° C. itself, as well as values close to 50° C. Thus, the phrases “about X” or “approximately X” include a description of the value X itself. If a range is indicated, such as “approximately 50° C. to 60° C.,” it is understood that both the values specified by the endpoints are included, and that values close to each endpoint or both endpoints are included for each endpoint or both endpoints; that is, “approximately 50° C. to 60° C.” is equivalent to reciting both “50° C. to 60° C.” and “approximately 50° C. to approximately 60° C.”

It is understood that aspects and embodiments of the invention described herein include the “comprising,” the “consisting,” and/or the “consisting essentially of” aspects and embodiments. For all methods, systems, compositions, and devices described herein, the methods, systems, compositions, and devices can either comprise the listed components or steps, or can “consist of” or “consist essentially of” the listed components or steps. When a system, composition, or device is described as “consisting essentially of” the listed components, the system, composition, or device contains the components listed, and may contain other components which do not substantially affect the performance of the system, composition, or device, but either do not contain any other components which substantially affect the performance of the system, composition, or device other than those components expressly listed; or do not contain a sufficient concentration or amount of the extra components to substantially affect the performance of the system, composition, or device. When a method is described as “consisting essentially of” the listed steps, the method contains the steps listed, and may contain other steps that do not substantially affect the outcome of the method, but the method does not contain any other steps which substantially affect the outcome of the method other than those steps expressly listed.

The systems, compositions, substrates, and methods described herein, including any embodiment of the invention as described herein, may be used alone or may be used in combination with other systems, compositions, substrates, and methods.

### Metal Substrates

Metal substrates used in the invention should have good thermal shock resistance, good corrosion resistance, and good mechanical shock resistance. Stainless steel can be used as a material for use as a catalytic converter substrate. Stainless steel with a chromium content of at least 12% is preferred.

A substrate suitable for use with the primer washcoats is Emitec Part No. 616394, a stainless steel monolith having 19% chromium and 3% aluminum.

Kanthal® steel can also be used for catalytic converter substrates. KANTHAL is a registered trademark of Sandvik Intellectual Property AB Corporation, Sandviken, Sweden, for steel having 20-30% chromium content and 4-7.5% aluminum content (with the remainder comprising iron).

The metal substrates are in a form suitable for use as catalytic converters. One suitable form is a honeycomb structure. Other forms include corrugated metal foils, or alternating sheets of corrugated and flat metal foil. Examples of metal foil structures suitable for use as metal substrates in the invention are disclosed in Brück, R. et al., “Flow Improved Efficiency by New Cell Structures in Metallic Substrates,” SAE Technical Paper 950788, 1995, doi:10.4271/950788; Held, W. et al., “Improved Cell Design for Increased Catalytic Conversion Efficiency,” SAE Technical Paper 940932, 1994, doi:10.4271/940932; Brück, R. et al., “Metal Supported Flow-Through Particulate Trap; a Non-Blocking Solution”, SAE Technical Paper 2001-01-1950, doi:10.4271/2001-01-1950; Chang, C. et al., “Aluminum Clad Ferritic Stainless Steel Foil for Metallic Catalytic Converter Substrate Applications,” SAE Technical Paper 960556, 1996, doi:10.4271/960556; and U.S. Pat. Nos. 4,301,039, 4,402,871, 4,886,711; and 5,366,139. Vendors of metal substrates suitable for use in the invention include Emitec (Emitec Gesellschaft für Emissionstechnologie mbH, Lohmar, Germany) and Metal Substrate (Coppell, Tex., United States of America).

The substrate as obtained from the supplier is washed with alcohol (such as ethanol or methanol) and deionized water, and then dried and calcined prior to use.

### Primer Washcoat Composition

The washcoat used to create the primer layer comprises boehmite. Boehmite (or bohmite) is also known as gamma-aluminum oxide hydroxide or hydrous aluminum oxide, and has the molecular formula AlO(OH), also written as Al₂O₃•H₂O. Boehmite can be purchased from numerous vendors. In some embodiments, the size of the boehmite particles can range from 0.5 micron to 100 microns in size.

In order to apply the boehmite to the metal substrate for use as a boehmite primer layer, an aqueous suspension of boehmite particles is prepared. Preferably, deionized water is used for the boehmite suspension, such as 18 Megaohm (that is, 18 Megaohm-cm) water available from various suppliers. Distilled water can also be used in some embodiments.

In some embodiments, dispersants, surfactants, or detergents can be added to the water used for the suspension. In one embodiment, a dispersant is used, in an amount of about 0.5% to about 6% (weight/weight), about 1% to about 5%, about 2% to about 4%, about 2.5% to about 3.5%, or about 3%. A preferred value is about 3%. Dispersants and surfactants suitable for use include Jeffsperse, such as Jeffsperse® X3202 (Chemical Abstracts Registry No. 68123-18-2, and described as 4,4′-(1-methylethylidene)bis-phenol polymer with 2-(chloromethyl)oxirane, 2-methyloxirane, and oxirane), Jeffsperse® X3204, and Jeffsperse® X3503 surfactants from Huntsman (JEFFSPERSE is a registered trademark of Huntsman Corporation, The Woodlands, Tex., United States of America for chemicals for use as dispersants and stabilizers), which are nonionic polymeric dispersants. Other suitable dispersants and surfactants include Solsperse® 24000 and Solsperse® 46000 from Lubrizol (SOLSPERSE is a registered trademark of Lubrizol Corporation, Derbyshire, United Kingdom for chemical dispersing agents).

The boehmite is added to water at a concentration of about 1% to about 20% (weight/weight), about 5% to about 20%, about 1% to about 15%, about 5% to about 15%, about 8% to about 12%, about 2% to about 12%, about 3% to about 12%, about 3% to about 10%, about 4% to about 8%, about 5% to about 8%, about 5% to about 7%, about 5.5% to about 6.5%, or about 4%, about 5%, about 6%, about 7%, about 8%, about 9%, about 10%, about 11%, about 12%, about 13%, about 14%, or about 15%. About 10% boehmite is a preferred value. About 6% boehmite is a second preferred value.

While other solids, such as aluminum oxide, can be mixed in with the boehmite for use in forming the primer layer, the boehmite should comprise at least about 80% by weight of the solids in the aqueous suspension. In other embodiments, the boehmite comprises at least about 90% by weight of the solids in the aqueous suspension, at least about 95% by weight of the solids in the aqueous suspension, at least about 99% by weight of the solids in the aqueous suspension, or at least about 99.5% by weight of the solids in the aqueous suspension. In other embodiments, the solids suspended in the aqueous suspension consist essentially of (or consist of) boehmite.

The aqueous boehmite suspension is stirred, and the pH of the suspension is adjusted to pH 4 with glacial acetic acid. In some embodiments, the suspension is then sonicated for up to about ten hours. After sonication, the suspension is centrifuged to remove large particles. The supernatant is decanted, and the supernatant of the centrifuged boehmite suspension can be used immediately to coat the metal substrate, such as by pouring the suspension through the metal honeycomb. A “waterfall” method can be used to coat the metal substrate, which entails pouring the suspension over the substrate repeatedly until the desired weight uptake is reached. In some embodiments, excess boehmite suspension is blown off with air, such as by use of an air knife. Air is blown over the suspension until it sets.

The boehmite coating on the substrate is then dried to remove the water. Typically, the substrate is dried at about 70° C., but can be dried at any temperature below the boiling point of water. The time of drying can vary between about 1-2 minutes to about 1-2 hours; a period of about 5 minutes at about 70° C. is used in one embodiment.

After drying, the boehmite-coated substrate is calcined, for example, at a temperature of about 500° C. to 700° C., typically at about 550° C., for a few hours to several hours. In one embodiment, the boehmite-coated substrate is calcined for about 2 hours at 120° C., then for about 2 hours at 550° C. Calcination oxidizes any organic contaminants, and provides for good adherence of the boehmite coating to the underlying substrate. The calcined, boehmite-coated substrate is then allowed to cool, resulting in a metal substrate having a primer layer comprising boehmite.

After calcining, the thickness of the boehmite primer layer (primer washcoat layer) can range from about 0.5 g/L to about 4 g/L, such as about 1 g/L to about 4 g/L, such as about 1.5 g/L to about 4 g/L, such as about 1 g/L to about 3.5 g/L, such as about 1 g/L to about 3 g/L, such as about 1 g/L to about 2.5 g/L, such as about 1 g/L to about 2 g/L, about 1.5 g/L to about 2.5 g/L, about 1.75 g/L to about 2.25 g/L, about 2 g/L, about 1 g/L to about 3.5 g/L, about 1.5 g/L to about 3.5 g/L, such as about 2 g/L to about 4 g/L, such as about 2 g/L to about 3 g/L, about 2 g/L to about 3.5 g/L, about 2.5 g/L to about 3.5 g/L, about 2.75 g/L to about 3.25 g/L, or about 3 g/L. A preferred thickness is about 3 g/L. A second preferred thickness is about 2 g/L.

As noted above, other solids, such as aluminum oxide, can be mixed in with the boehmite for use in forming the primer layer. In the resulting metal substrate with a calcined boehmite-comprising primer layer, the boehmite should comprise at least about 80% by weight of the primer layer. In other embodiments, the boehmite comprises at least about 90% by weight of the primer layer, at least about 95% by weight of the primer layer, at least about 99% by weight of the primer layer, or at least about 99.5% by weight of the primer layer. In other embodiments, the primer layer consists essentially of (or consists of) boehmite.

Any desired washcoat can then be applied to the substrate having a calcined boehmite primer layer, such as a corner-fill layer (typically, aluminum oxide), a zeolite-containing layer, a cerium oxide-containing layer (such as an HSA-20-containing layer), or a platinum group metal-containing layer. Examples of washcoats that can be used included washcoats incorporating the catalysts disclosed in U.S. Pat. Nos. 8,507,401, 8,575,059, 8,481,449, 8,652,992, 8,557,727, 8,669,202,and United States Patent Application Publication No. US 2011/0143916. The washcoats disclosed in the following publications can also be used: U.S. Pa. No. 8,679,433, United States Patent Application Publication No. 2014/0140909; and U.S. Application Nos. 61/858,551, 61/894,341, 61/894,346, 61/915,973, 61/969,035, and 61/985,388.

The disclosures of all publications, patents, patent applications and published patent applications referred to herein by an identifying citation are hereby incorporated herein by reference in their entirety.

Although the foregoing invention has been described in some detail by way of illustration and example for purposes of clarity of understanding, it is apparent to those skilled in the art that certain changes and modifications will be practiced. Therefore, the description and examples should not be construed as limiting the scope of the invention.

What is claimed is:

1. A coated metal substrate comprising a metal substrate and a primer layer comprising boehmite disposed directly on the metal substrate, wherein the primer layer comprises at least 80% boehmite.

2. The coated metal substrate of claim 1, wherein the metal substrate has a honeycomb structure or corrugated metal foil structure.

3. The coated metal substrate of claim 1, wherein the primer layer on the metal substrate has been calcined.

4. The coated metal substrate of any one of claims 1-3, wherein the primer layer is present in an amount of about 1 g/L to about 4 g/L.

5. The coated metal substrate of claim 4, wherein the primer layer is present in an amount of about 3 g/L.

6. The metal substrate of any one of claims 1-5, wherein the metal substrate is stainless steel.

7. The metal substrate of claim 6, wherein the stainless steel comprises at least 16% chromium.

8. The metal substrate of claim 6 or claim 7, wherein the stainless steel comprises at least 3% aluminum.

9. The coated metal substrate of any one of claims 1-8, further comprising an additional washcoat layer disposed directly on top of the primer layer.

10. A method of making the coated substrate of claim 1, comprising:
a) providing a metal substrate;
b) forming an aqueous suspension of boehmite particles;
c) applying the boehmite particle suspension to the metal substrate; and
d) drying and calcining the metal substrate having the applied boehmite.

11. The method of claim 10, wherein the metal substrate comprises stainless steel.

12. The method of claim 10 or claim 11 wherein deionized water is used for forming the aqueous suspension of boehmite particles.

13. The method of any one of claims 10-12, wherein the aqueous solution further comprises a dispersant.

14. The method of claim 13, wherein the dispersant comprises a nonionic polymeric dispersant.

15. The method of any one of claims 10-14, wherein the boehmite particle suspension is sonicated before applying to the metal substrate.

16. The method of claim 15, where the boehmite particle suspension is centrifuged after sonication, and the supernatant of the centrifuged suspension is applied to the metal substrate.

17. The method of any one of claims 10-16, wherein the calcining is performed for at least about two hours at a temperature between 500° C. and 600° C.

18. The method of any one of claims 10-17, wherein after calcining, the primer layer on the coated substrate has a thickness of about 1 g/L to about 4 g/L.

19. The method of any one of claims 10-17, wherein after calcining, the primer layer on the coated substrate has a thickness of about 3 g/L.

20. The method of any one of claims 10-19, further comprising:
e) depositing an additional washcoat layer directly on top of the primer layer.
